(19) United States
(12) Patent Application Publication
(10) Pub. No.: US 2007/0194068 A1
(43) Pub. Date: Aug. 23, 2007

(54) Vehicle mounted ladder rack

(76) Inventor: Michael Kirk Thompson, Joplin, MO (US)

Correspondence Address: MIKE THOMPSON, 1121 OAKMONT DR., JOPLIN, MO, 64804, US

(21) Appl. No.: 11/703,397

(22) Filed: Feb. 7, 2007

Related U.S. Application Data
(60) Provisional application No. 60/774,395, filed on Feb. 17, 2006.

(51) Int. Cl. E06C 5/00; B60R 9/00; B60R 11/00

(52) U.S. Cl. 224/319; 224/558; 182/127

(57) ABSTRACT

A vehicle mounted ladder rack (10), bent in such a way as to allow secure stowage yet easy removal of a ladder. Fixed mounting clamps (22) are welded on the underside of rack (10). The fixed clamps (22) and lower clamps (20) are drilled (18) to allow the bolts (14) to pass through. The bolts (14) are then secured with nuts (16). Tightening of these nuts compresses lower clamps (20) into the bottom of a standard vehicle luggage rack. This secures the ladder rack (10) in place atop the vehicle. A set of two racks (10) is required to securely hold a ladder on the vehicle, one mounted on the forward luggage rack and one on the rear.

### CROSS-REFERENCE TO RELATED APPLICATIONS

This application claims the benefit of provisional patent application Ser. No. 60/774,395 filed Feb. 17, 2006 by the present inventors

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to ladder racks and holders, specifically vehicle luggage rack mounted ladder racks.

2. Prior Art

Ladders have been carried atop cars for years. Current apparatuses for transporting ladders on vehicles are either overly complex or require ropes, tie-downs or bungee cords to secure the ladder to the carrier rack. It is not uncommon for the ropes and tie-downs to break, causing the ladder to come loose and fall from the carrier rack resulting in equipment damage. It is especially dangerous for a ladder to fall while the vehicle is in motion on the highway, since such ladder can interfere with other vehicles on the highway resulting in accidents and death.

Consequently, there exists an unfulfilled need for an apparatus to simply and securely hold a ladder atop a vehicle. Such apparatus should be easy to operate and sturdy enough to prevent a ladder from release until desired.

Patents which may be related to the above issues include the following:
U.S. Pat. No. 5,058,791, issued Oct. 22, 1991, to Henriquez et al. discloses a vehicular ladder rack comprising a stationary mounting frame including a pair of transverse frame members affixed to the roof of a vehicle, a positioning assembly including a pair of positioning members affixed to opposite end portions of an elongated longitudinal positioning element rotatable between a first and second position coupled to the pair of transverse frame members and a ladder support frame including a pair of ladder support members movable between a first and second position to support a ladder thereon operatively coupled between the pair of transverse frame members and the corresponding positioning member such that a ladder is supported over the roof of the vehicle for storage and transportation when the elongated longitudinal positioning element and ladder support frame are in the first position and the ladder support frame is moved from the first to the second position when the elongated longitudinal positioning element is rotated from the first to the second position to move the ladder support frame from the first to the second position adjacent the side of the vehicle to permit a ladder to be mounted thereon or removed therefrom.
U.S. Pat. No. 4,887,750, issued Dec. 19, 1989, to R. K. Dainty, discloses a rack arrangement for supporting a load, for example above the roof of a vehicle body, and comprises a pair of substantially parallel elongate guide members each having a lower upwardly extending portion and an upper load supporting portion. A load carrier member is lockably connected to the guide members and is manually slidable from a lowered position upwardly along the lower guide member portions 3a onto the supporting portions to a load storage position. Means are provided for releasably retaining the carrier member in the load storage position, for example a cup-like recess, which locates the base of a handle for the carrier member.
U.S. Pat. No. 4,826,387, issued May 2, 1989, to M. Audet, teaches that heavy materials such as ladders, pipes and the like are often carried on a roof rack secured to the roof of service trucks, vans and the like and of course are difficult to place on the rack and remove therefrom. The present device includes a carrier which can be extended and retracted relative to the rack and is hinged so that it drops down adjacent the sides of the truck when extended, to facilitate loading and unloading of the material carried by the rack. When hinged upwardly to approximately the horizontal position, it may be pushed towards the longitudinal center of the roof so that it telescopes inwardly thus supporting the material upon the rack. Automatic latches are included to detachably lock the carrier in the retracted position and snubbers are provided to space the carrier from the side walls of the van or truck when in the extended, substantially vertical position.
U.S. Pat. No. 4,262,834, issued Apr. 21, 1981, to W. H. Nutt, teaches a vehicle roof rack which comprises a rack frame and a releasable clamping device for releasably clamping a ladder thereto. The clamping device includes a clamp arm which is pivoted to a rigid support and operated by a crank mechanism by moving across a dead-center position to clamp the ladder in place. Clamping members are resiliently supported on the clamp arm to engage the ladder and exert a clamping pressure on it.
U.S. Pat. No. 4,390,117 discloses a ladder rack for a vehicle roof which comprises a sub-frame having clamps for releasable attachment to the roof of a vehicle. The sub-frame carries front and rear ladder support assemblies each comprising transverse rollers for engaging the stringers of a ladder spanning the two assemblies. Each support assembly further comprises a respective ladder-retaining member manually pivotal about a transverse axis from a lowered inoperative position to a raised rung-engaging position. The front and rear ladder-retaining members are operated by a handle or handles pivoted at one side of the rear support assembly, either independently or simultaneously. Furthermore, the rollers of the front support assembly are mounted to be manually raised and lowered. A ladder spanning the assemblies may be brought into a downwardly and rearwardly inclined orientation for off-loading from the rear of the vehicle. The manual operation of the front rollers is independent of the manual operation of at least the rear ladder-retaining member, so that a ladder may be brought to the inclined position in preparation for unloading while still being retained on the rack by the rear ladder-retaining member.

The above-listed patents do not disclose means that solve the problems discussed hereinbefore. Consequently, there remains a need for a relatively inexpensive means for locking ladders to racks of many different types which may be utilized to provide safer and more reliable transportation of ladders on vehicles on already existing vehicular racks as well as newly designed racks. Those skilled in the art have long sought and will appreciate the present invention which provides solutions to these and other problems.

### BACKGROUND OF INVENTION—OBJECTS AND ADVANTAGES

The advantages of this device over the prior-art are:
(a) to be user-insalable as an after-market part. As such, installation is very simple with the consumer only needing to tighten several nuts. This requires no technical skill other than using pliers or a wrench;
(b) to provide a part which is non-permanent
(c) to give the consumer a simple, yet effective solution to the problem of transporting ladders on top of vehicles.
(d) to allow easy insertion and removal of a ladder whilst keeping it secure at all times.
(e) to be able to be produced easily, and at low cost

### SUMMARY

In accordance with the present invention, a vehicle mounted ladder rack comprises a singular strip of stiff material bent in such a way to securely hold a ladder atop a vehicle. It is to be mounted to the vehicle's luggage rack with mounting clamps.

### DRAWINGS—FIGS.

FIG. 1 is an isometric view of the entire ladder rack assembly

FIGS. 2A, 2B, 2C show how the device is to be used.

FIG. 3 is a front view of the ladder rack

FIG. 4 is an alternative embodiment of the ladder rack

### DRAWINGS—REFERENCE NUMERALS

10—ladder rack bar
12—C-shaped mounting clamp
14—bolt
16—nut
18—bolt hole
20—lower mounting clamp
22—fixed mounting clamp
24—luggage rack lateral bar

### DETAILED DESCRIPTION—FIGS. (1-3)

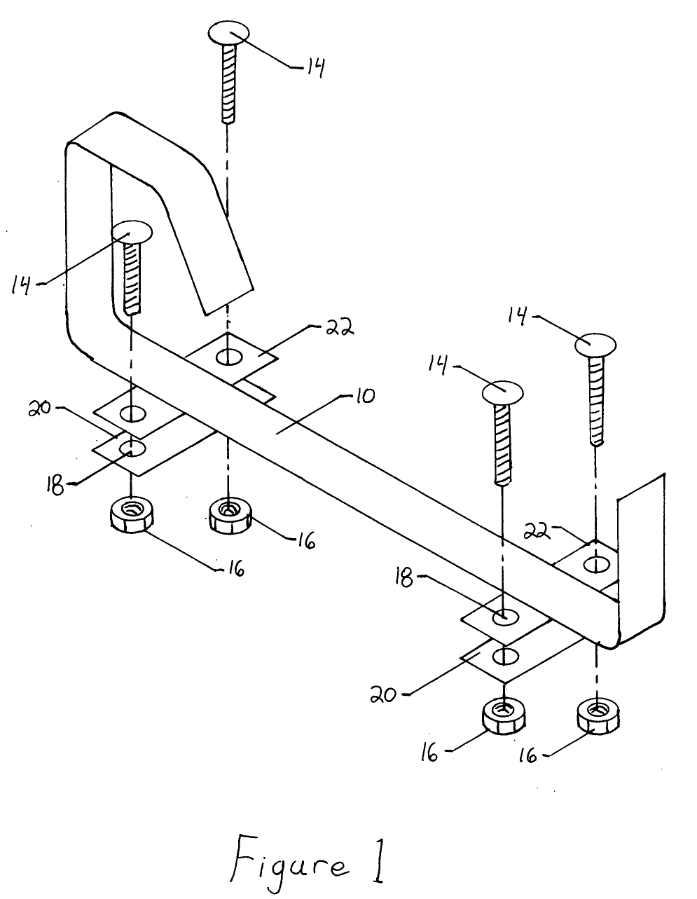

FIG. 1 shows the preferred embodiment of the present invention. Ladder rack bar 10 is bent upward at each end. One of these upward bends is bent back parallel to the base of ladder rack bar 10. This top parallel bend is then bent downward toward the base bar.

Set in from each end on the underside of ladder rack bar 10 are fixed mounting clamps 22. The fixed mounting clamps 22 are welded to the underside of ladder rack bar 10. The fixed mounting clamps 22 and lower mounting clamps 20 are flat and drilled at both ends to allow bolts 14 to pass through bolt holes 18.

Nuts 16 are then tightened onto the ends of bolts 14 to secure the ladder rack 10 to the vehicle.

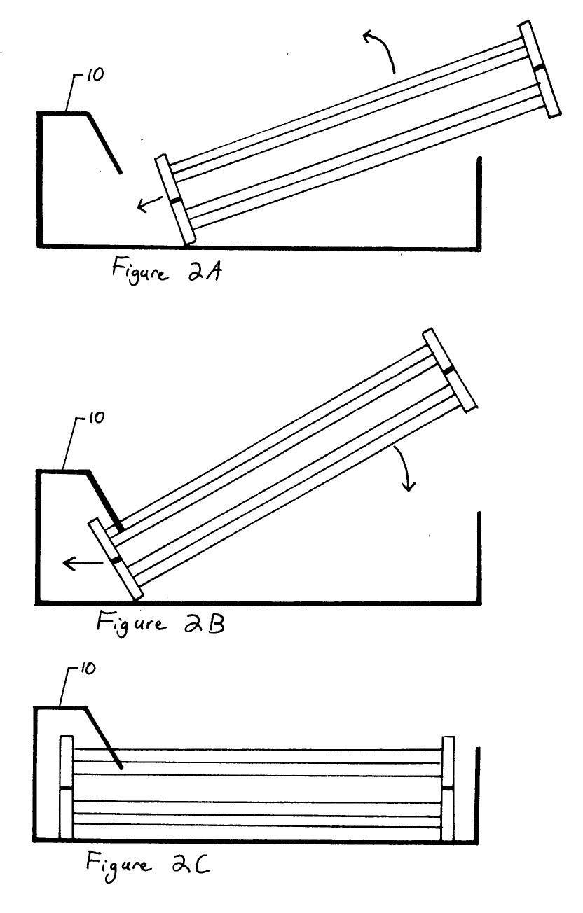

### OPERATION—FIGS. 1, 2A, 2B, 2C

To use the ladder rack 10, the fixed mounting clamps 22 are centered on top of a lateral bar of a vehicle luggage rack. Bolts 14 are then inserted through bolt holes 18, in the fixed clamp 22 and bolt holes 18 in the lower clamps 20 and secured with nuts 16. The rack is secured by tightening nuts 16 until the lower clamps 20 are squeezed tightly onto the luggage rack. One ladder rack is to be mounted to the forward luggage rack and one mounted on the rear. They should be aligned so that a ladder, when inserted, lies parallel to the longitudinal axis of the vehicle.

FIG. 2A shows how to use the vehicle mounted ladder rack. To insert a ladder, lift it over the short vertical side of rack 10. Slide it along the rack and hook the far side of the ladder under the hooked portion of rack 10 as shown in FIG. 2B. The ladder will then rotate down and lie flat along the bottom of the ladder rack 10 as in FIG. 2C. It is held in place laterally by the two vertical bends in the rack. It is held in place longitudinally by the hook portions which catch on the rungs of the ladder. To remove the ladder, simply reverse the process illustrated in FIGS. 2A-2C.

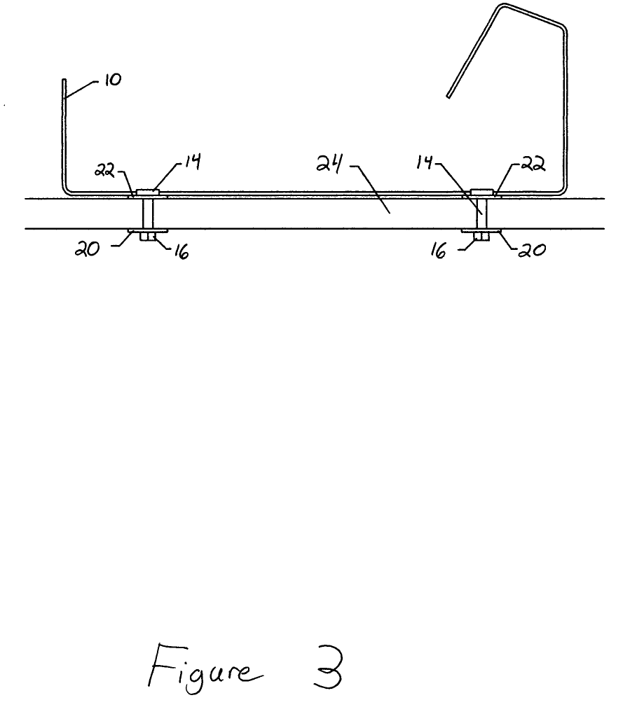

FIG. 3 shows the shape of ladder rack 10 as viewed from the front or rear of the vehicle when installed. Ladder rack 10 sits on top of luggage rack 24. Bolts 14 pass through the fixed clamps 22 and the lower clamps 20, and are secured by nuts 16. The luggage rack 24 is then securely pinched between the clamps, securing ladder rack 10 to the vehicle.

### Alternative Embodiments

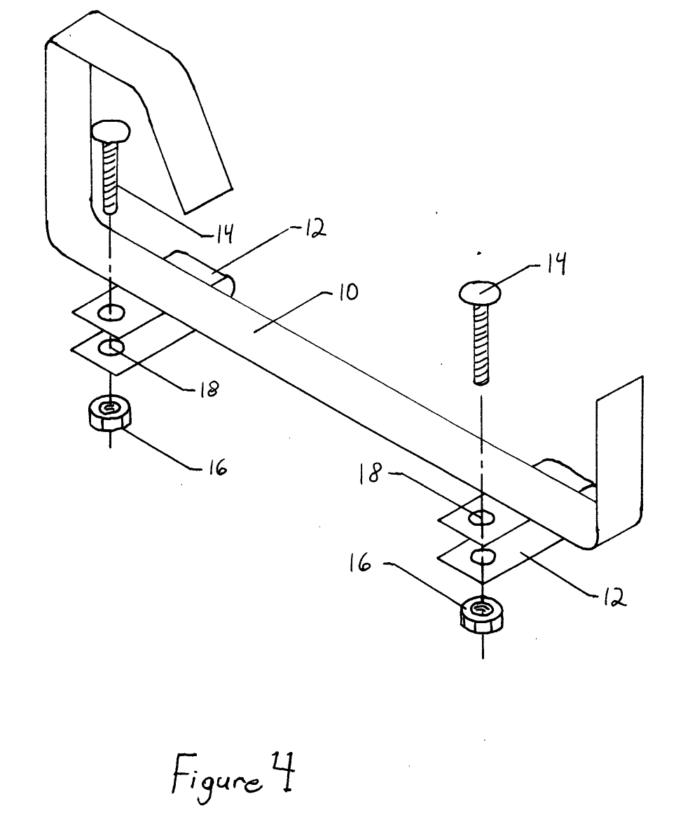

FIG. 4 shows ladder rack 10 with C-shaped clamps 12 welded on instead of flat bars. This design allows the use of only two bolts 14 and nuts 16. The nuts 16 are tightened to close the clamps around a luggage rack.

### Additional Ramifications

Many different materials can be used to produce the disclosed device. Some of these materials are, but are not limited to, plastic, metal, composites, or any combination of these.

### Advantages

From the description above, it is easy to see that the Vehicle-Mounted Ladder Rack has a number of advantages over the prior-art:
a) It is a very simple design, having few parts.
b) It is easy to install by just slipping it over the luggage rack of a vehicle and tightening several nuts.
c) It provides a solution which is non-permanent
d) It gives the consumer a simple, yet effective solution to the problem of transporting ladders on top of vehicles.
e) It allows easy insertion and removal of a ladder whilst keeping it secure at all times.
f) It is able to be produced at low cost.

Although the description above contains many specificities of the disclosed invention, these should not be construed as to limit the scope of the invention. Rather, they provide examples of some of the preferred and possible embodiments of this invention. As such, the scope of this invention should be determined by the following claims and their legal equivalents rather than the examples given above.

That which is claimed is:

1) A device for securing a ladder on top of a vehicle comprised of:
a) a bent bar for means of securing a ladder to a vehicle
b) said bar having a flat lower portion long enough to accommodate the width of a common extension ladder
c) the bar being bent perpendicular on each side of said lower portion, forming sides to hold said ladder in place
d) one side of said perpendicular bends being of sufficient height to keep a ladder from sliding over it
e) the opposing, parallel side being of sufficient length to accommodate the ladder rotating in and out of position
f) said opposing side then being bent back perpendicular to the side and parallel to the lower flat portion, forming a top portion, whereby securing the ladder from bouncing out the top
g) said top then being bent downward toward the lower portion of sufficient length to engage the rungs of the ladder, whereby keeping the ladder from sliding longitudinally
h) a plurality of laterally disposed and perpendicularly oriented clamps welded onto said bar.
